(19) United States
(12) Patent Application Publication
(10) Pub. No.: US 2012/0228240 A1
(43) Pub. Date: Sep. 13, 2012

(54) Intelligent Display And Fixture System

(75) Inventors: John Gentile, Montclair, NJ (US); Anthony Gentile, New York, NY (US); Steven Martin Cohen, New York, NY (US); Scott Wilker, Glen Rock, NJ (US)

(73) Assignee: T-INK, LLC, New York, NY (US)

(21) Appl. No.: 13/414,889

(22) Filed: Mar. 8, 2012

Related U.S. Application Data
(60) Provisional application No. 61/450,395, filed on Mar. 8, 2011.

(51) Int. Cl. A47F 5/00; H01R 43/00

(52) U.S. Cl. 211/1; 211/134; 29/825

(57) ABSTRACT

According to an embodiment of the invention, a configurable merchandise display system comprises a base, a peg board associated with the base and a shelf. The peg board is configured to conduct electrical current and comprises a plurality of electrical sockets. The shelf is configured to be removably coupled to and in electrical communication with the peg board via at least a first and a second of the plurality of electrical sockets. The shelf is further configured to removably accommodate at least one product thereon, and to be in electrical communication with the at least one product. A controller is configured to control at least an electrical current flowing to and from the peg board and the shelf.

### CROSS-REFERENCE TO RELATED APPLICATIONS

This application claims the benefit of the filing date of U.S. Provisional Patent Application No. 61/450,395 filed Mar. 8, 2011, the disclosure of which is hereby incorporated herein by reference in its entirety.

### FIELD OF INVENTION

The invention is related to the field of interactive and intelligent consumer, commercial, and industrial configurable display and fixtures and their respective power distribution control systems, data capturing, distribution capabilities, and the interaction with consumer products designed to be controlled by the display fixture or other inputs.

### BACKGROUND OF THE INVENTION

Conventional displays, such as point-of-purchase displays having a base pegboard and display hardware, are either shipped assembled or assembled in the field and contain a limited and specific functional capability with the modifiable elements limited to the placement of shelves, racks, and corresponding hooks upon which products are placed and displayed. Certain displays have some form of a hard-wired battery pack or electrical connection (e.g., 110V or 220V AC) that trigger a light or sound element, or perhaps a proximity or motion sensor to detect the presence of a potential consumer to activate a visual or aural component. Moreover, conventional point-of-purchase displays offer little if any sales or marketing data feedback to the product manufacturer, retailer, or consumer.

Of utility there is an integrated solution that provides an eye-catching and attention-grabbing interactive product display to capture consumer attention while, at the same time, providing sales and similar information concerning the displayed products back to the manufacturer and/or retailer.

### BRIEF SUMMARY OF THE INVENTION

In one aspect, the present invention is an interactive intelligent display system suitable, for example, for point-of-purchase scenarios. It has all the functionality of traditional displays, but also includes a new form of a power distribution system that can either replace existing wired components with a printed or molded conductive ink trace on, in, or around the display unit, or work in conjunction with legacy wired systems for further product enhancements.

For example, in one aspect of the invention, the peg board (also called the backer board) normally associated with a display has a printed conductive ink trace applied to the front (A Side) or back (B Side) of the peg board in at least one of a multitude of ways. In another aspect of the invention, a display may be composed of a corrugated or other printed or laminated substrate that may or may not be disposable. The invention contemplates including, but is not limited to, applications of such conductive ink trace inclusion methods as a direct print (for example, silkscreen) on the peg board or on a printed corrugated material, an embedded ink layer in the board laminate material or a laminated material applied to a corrugated or other substrate, as a separate sheet applied to or heat transferred on the board or a corrugate, pad printed, sprayed on, or applied with a gummed substrate such as a conductive tape or pad. When the fixture hooks, shelves, or other elements are plugged into the peg board (or such other material utilized as the backer board), they come in contact with the proper power traces on the back or front side, thereby allowing for the proper contact and distribution of a positive and negative contact, thereby creating a powered component. That is, the hooks and/or the shelves, be they corrugated or not, acquire current from the peg board and/or corrugate and can in turn power other visual, aural, or similar elements (to be discussed below). The system is modular in nature allowing for the addition to, or replacement of components to the fixture that create greater interactivity and enhance marketing opportunities with the consumer. The display may optionally be a corrugated self-shipping article in which the display base and/or other parts form part or all of the shipping container for the display system.

In conjunction with the conductive ink power distribution capabilities, the display system contains a variety of hooks, shelves, drawers, power rails, power poles, etc. that plug into the power conductive ink traces and can further control the distribution of power and/or audio on or around a peg board, onto or around shelf units, drawers, hangers, etc. This allows for a wide variety of product presentation accessories to be powered and utilized with products placed onto the fixture. The power may be provided by modular battery systems, and may be rechargeable.

According to an embodiment of the invention, a configurable merchandise display system comprises a base, a peg board associated with the base and a shelf. The peg board is configured to conduct electrical current and comprises a plurality of electrical sockets. The shelf is configured to be removably coupled to and to be in electrical communication with the peg board via at least a first and a second of the plurality of electrical sockets. The shelf is further configured to removably accommodate at least one product thereon, and to be in electrical communication with the at least one product. A controller is configured to control at least an electrical current flowing to and from the peg board and the shelf.

In another embodiment, the peg board further comprises a plurality of electrically conductive elements selected from the group consisting of conductive ink prints, conductive ink traces and copper wiring.

In another embodiment, the peg board further comprises a printed ink trace applied to at least one of a front and a back side of the peg board.

In another embodiment, the peg board further comprises an embedded conductive ink layer.

In another embodiment, the peg board is configured to receive electrical power from a first power source, and the shelf is configured to draw electrical power from said first power source via said base or from a second power source.

In another embodiment, the shelf further comprises one or more of a lighting element, an audio element, a data acquisition element, a touch sensor, and a proximity sensor.

In another embodiment of the invention, the system further comprises a projection element configured to project at least one of light, a light effect, a still image, and a video image.

In another embodiment, the controller is configured to maintain the electrical current flowing through at least one of the peg board and said shelf, from exceeding a predetermined threshold.

In an embodiment of the invention, the base comprises a display panel.

In an embodiment, the display system further comprises one or more of a capacitive sensor, a touch sensor, a biometric sensor, a proximity sensor, a force register, a sound sensor, and a light sensor in communication with the controller.

In another embodiment, the system comprises one or more wireless communication devices for at least one of an internal wireless communication within the fixture and an external wireless communication with an external system, wherein said wireless communication devices comprise one or more of Bluetooth devices, infrared devices and radio frequency devices.

According to an aspect of the invention, a method for displaying a product comprises the steps of removably coupling one or more shelves to a peg board and positioning a product on the shelf. The shelf is configured to be in electrical communication with the peg board, and the peg board is configured to receive electrical power from a first power source. The product is configured to be in electrical communication with the shelf.

According to an aspect of the invention, the method further comprises the step of sensing, via a change in the electrical current flowing between the shelf and the peg board, removal of the product from the shelf.

According to an aspect of the invention, the method further comprises the step of establishing a wireless communication, via a wireless communication device, with a telecommunication device within a predetermined distance from the peg board.

According to an aspect of the invention, the method further comprises the step of actuating one or more of a visual and an audio element responsive to a detection of the presence of an individual within a predetermined distance from the peg board.

According to an aspect of the invention, the method further comprises the step of controlling, via a controller, an electrical current flowing through one or more of the peg board, the shelf and the product.

According to an aspect of the invention, wherein at least a first and a second product are positioned on the shelf, the method further comprises the step of differentially displaying the first and second products using at least one of a light element and an audio element.

According to an aspect of the invention, wherein a plurality of products are positioned on the shelf, the method further comprises the step of selectively displaying one or more of the plurality of products responsive to an input from an individual.

According to an aspect of the invention, the method further comprises the step of acquiring, via electrical communications with the shelf, real time sales and inventory data regarding at least one product positioned on the shelf.

According to another embodiment of the invention, a system comprises a configurable merchandise display system, as described above, and a server. The display system is configured to be communicatively coupled to the server.

According to yet another embodiment of the invention, the system comprises a plurality of configurable merchandise display systems in a networked communication with a server. The display systems may be configured to transmit and receive, for example, product information and customer information from one or more databases on the server. For example, the display system may receive prior purchase history of an identified customer or receive product update information from the server. The display system may transmit information regarding the sales data of the products displayed thereon to the server. The display system may also communicate with a telecommunication device associated with a customer and provide information such as promotional offers for one or more products displayed thereon, other product information, including but not limited to, price and ingredients, for example, to the customer.

### BRIEF DESCRIPTION OF THE DRAWINGS

FIG. 1 is a perspective view of a powered merchandise display system in accordance with an exemplary embodiment of the invention.

FIG. 2 is a front elevational view of a powered peg board or backing board in accordance with the embodiment of FIG. 1.

FIGS. 3A-C are perspective schematics of powered shelving and related display hardware for use in connection with the powered merchandise display system of FIGS. 1-2.

FIG. 4 is a perspective schematic of an in-package power conductor for drawing current from the powered merchandise display system of FIGS. 1-3 to a powerable device associated with product hanging on the powered display system.

FIG. 5 is a schematic representation of other optional powered devices to be used in conjunction with a powered merchandise display system in accordance with the invention.

FIG. 6 is one embodiment of a circuit diagram of a powered merchandise display system in accordance with the invention.

FIG. 7 is an embodiment of a system including a plurality of display systems connected via a network to a server, according to an embodiment of the invention.

FIG. 8 is flow chart for a method of displaying a product, according to an aspect of the invention.

### DETAILED DESCRIPTION

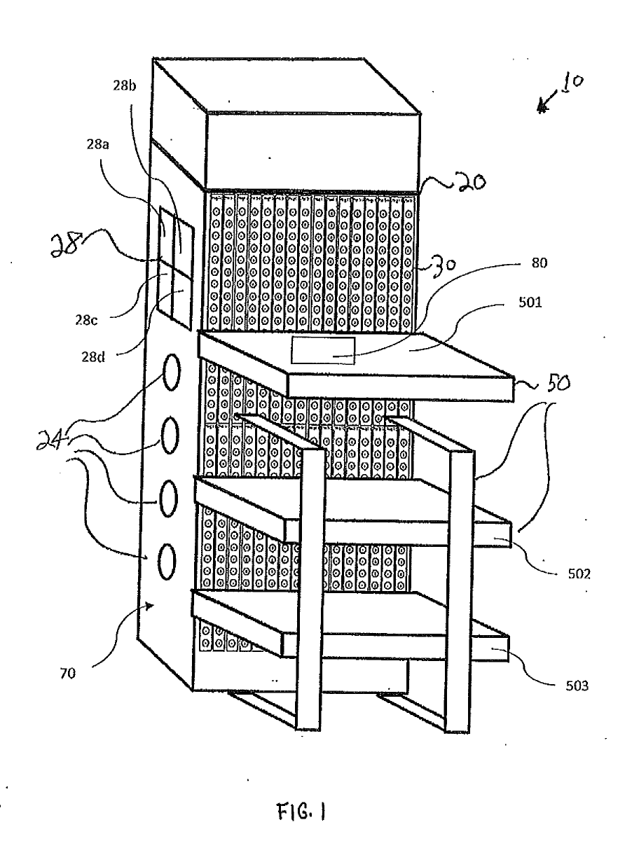

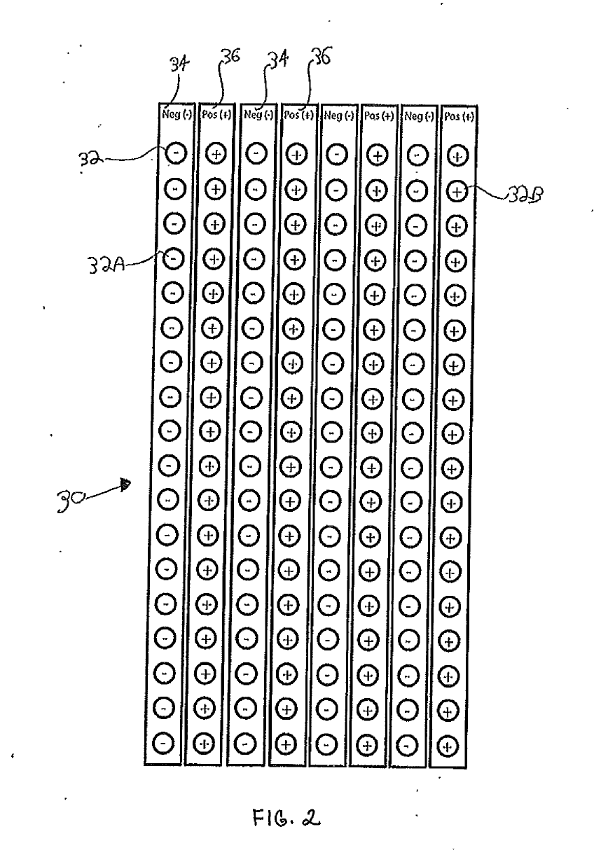

Description will now be given with reference to the attached FIGS. 1-8. It should be understood that these figures are exemplary in nature and in no way serve to limit the scope of the invention.

An exemplary embodiment of the powered merchandise display and fixture system in accordance with the invention is depicted in FIG. 1 as a display system 10. In overview, display system 10 includes a base 20 having a power-conductive peg board 30 as well as a power-conductive shelving 50. In the illustrated embodiment, shelving 50 includes a first shelf 501, a second shelf 502, and a third shelf 503. It will be understood that in other embodiments, shelving 50 may include a different number and a different types of shelves. An exemplary product or product packaging 80 is schematically illustrated resting on shelf 501. Base 20 may include one or more interactive sensors 24 and/or a display panel 28 the purpose of which will be clarified below. A power source (not shown), such as a 110V or 220V AC source, or a battery-type DC source, is provided and provides power to power-conductive peg board 30. Base 20 further includes a control board unit or controller 70 arranged therewithin (not visible in FIG. 1). In the illustrated embodiment, base 20 includes a display panel 28 comprising display segments 28a, 28b, 28c, and 28d.

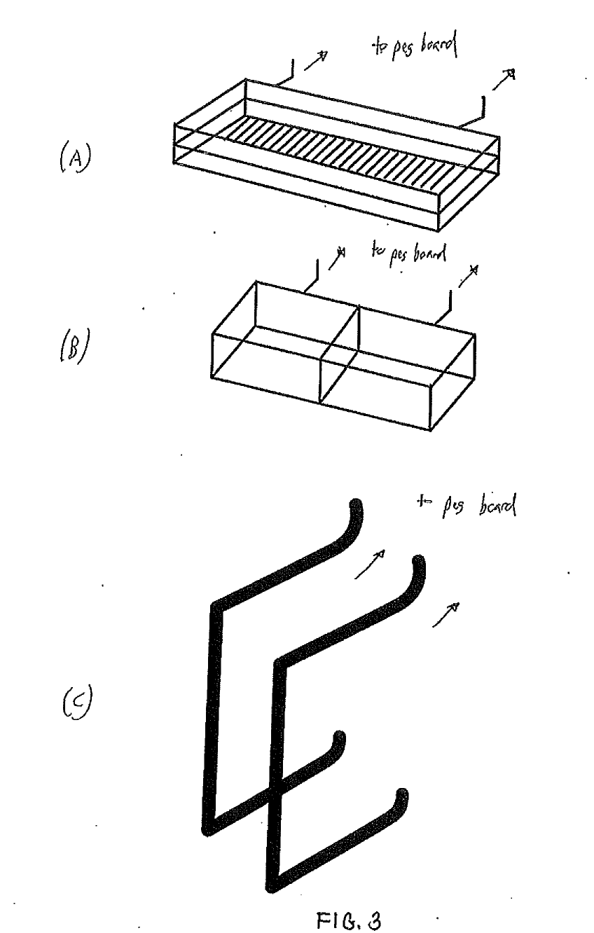

As best illustrated in FIG. 2, power-conductive peg board 30 includes a series of sockets 32, some of which are negative in polarity (32A) and some of which are positive in polarity (32B). While the arrangement of the sockets can be made in nearly any imaginable format, the preferred embodiment contemplated provides a grid or array of lines 34 of negative sockets 32A parallel to and alternating with lines 36 of positive sockets 32B. In this way, it is easy to configure and re-configure the powered display 10 over and over again for different products requiring different spacing, shelving needs, etc. without changing or retrofitting the hardware itself (apart from replacing modular shelving 50, see below).

The rear surface (not shown) of peg board 30 is preferably “wired” to the power source via conductive ink prints and traces. Although traditional insulated copper wiring (and the like) may be employed, the exemplary embodiment contemplates the use of conductive ink in any of a variety of patterns. Conductive ink can either replace or work in conjunction with existing wired components with a printed or molded conductive ink trace on, in, or around the display unit, or it can work in conjunction with legacy wired systems for further product enhancements. For example, the peg board (backer board) 30 normally associated with a display system 10 can have the printed ink trace applied to the front (A Side) or back (B Side) of the peg board in a multitude of ways such as a direct print (for example, silkscreen) on the peg board, an embedded ink layer in the board laminate material, as a separate sheet applied to or heat transferred on the board, pad printed, sprayed on, or applied with a gummed substrate such as a conductive tape or pad. When the fixture hooks, shelves, or other elements of shelving 50 are plugged into the peg board (or such other material utilized as the backer board) 30, they come in contact with the proper power traces on the back or front side of peg board 30 allowing for the proper contact with a positive and a negative voltage contact and distribution of a current or power, thereby creating a powered component. The display system 10 is modular in nature allowing for the addition to, or replacement of components to the fixture that create greater interactivity and enhance marketing opportunities with the consumer.

As mentioned briefly above, and as seen in FIG. 1 in a schematic manner, the system 10 includes powered shelving 50. Shelving 50 serves the dual purpose of both a) holding and displaying one or more products 80 to be sold, and b) conducting power from base 20 to the products 80 being displayed and/or other powerable display elements associated with display system 10. Shelving 50 includes a variety of hooks, shelves, drawers, power rails, power poles, etc. that plug into sockets 32 and thus contact the power conductive ink traces and can further control the distribution of power and/or audio signals on or around peg board 30, onto or around shelf units, drawers, hangers, etc. of shelving 50. Thus, the product merchandised 80 is advantageously integrated into along with the display system 10.

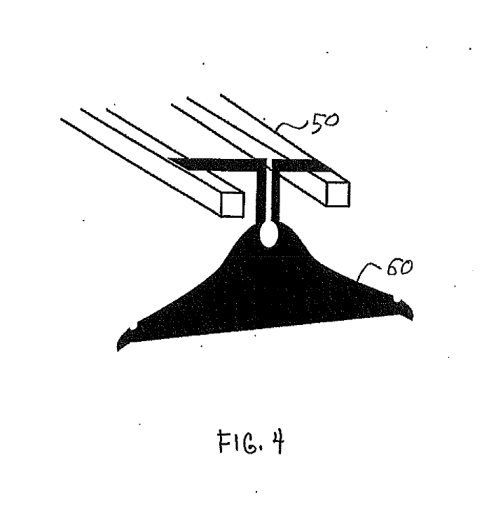

FIGS. 3A-C illustrate three of a number of contemplated versions of display system 10 hardware referred herein generally as powered shelving. Shelving 50 in FIGS. 3A-C, which may comprise corrugate, for example, a thermoformed plastic, or such other substrate, may contain printed trace circuits that can draw electrical power from either a battery power-pack, or via a power distribution system via the positive and negative bars plugged into powered peg board backer 30. Such a shelf 501, 502, 503 can power, including but not limited to, lighting elements, sound or audio elements, data acquisition and collection sensors, touch, proximity and other sensors incorporated in or associated with display system 30. Additionally, products and packaging 80 that are designed to sit on, touch, or be in close proximity to this shelving 50 can further draw electrical power from the shelf units 501, 502, 503 of shelving 50, and drive additional interactivity, product intelligence, and marketing capturing capabilities.

Such capabilities include, for example but are not limited to, the ability to sense when products 80 are swept off a shelf 501, 502, 503 in bulk, indicating a potential theft of products, the ability to determine how many products 80 have been picked up from shelving 50, when, the time of day, the ability to capture consumer data from any radiating or wireless signals emitting and/or receiving devices such as a phone, PDA, tablets, etc., and the ability to act as a anti-counterfeiting device insuring that only authorized packages 80 are placed on the display system 10.

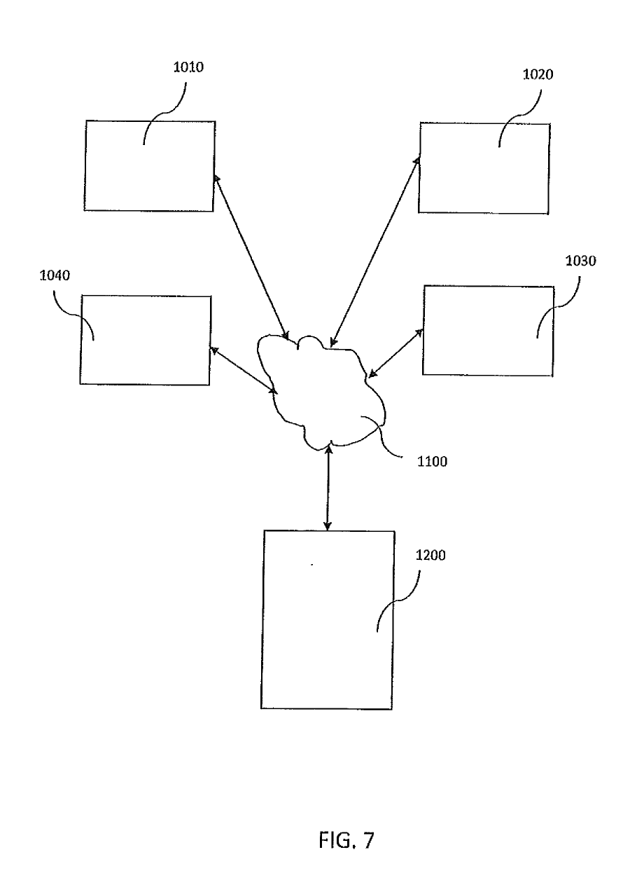

A wireless data feed may be provided to display system 30 via a network 1100 (FIG. 7) to, for example, trigger some form of interaction with a customer. A number of elements associated with display system 30 includes, by way of non-limiting examples only, a projector of light or light effects, still images, video images, or other media such as text and other graphic indicators. This allows for a wide variety of product presentation accessories to be powered and utilized with products placed onto the display and fixture system 10.

In an exemplary embodiment, display system 10 is designed or configured to be current limited so that it does not exceed a specified milliampere for the safety of the individuals interacting therewith as well as of the products 80 displayed thereon. In the exemplary embodiment, display system 10 draws approximately 5 volts to the powered shelving 50, and the amperage will be dependent, for example, upon the input power and the number of packages 80 on each hook or shelf 501, 502, 503 on shelving 50. If any rails of shelving 50 are shorted, for example, display system 10 prevents damage to one or more products 80 on shelving 50, and preferably eliminates heat and electrical shock to a consumer or any other individual interacting with system 10. For instance, if a vandal were to deliberately place a paper-clip across the rails of display system 10, the control board or unit 70 will sense a concomitant spike in the electrical current flowing therethrough and shut that channel down until the short is removed and rebooted, for safety reasons, and protect itself (and of course not allow harm to the consumer). The display system 10 is preferably continuously self diagnostic, e.g., checking for improper current, voltage, or resistance.

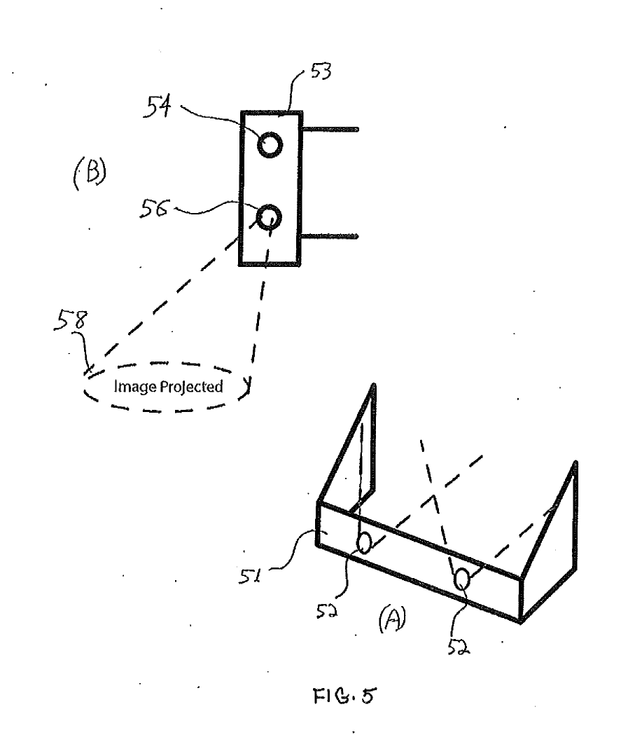

FIG. 4 depicts a conductive trace 60 formed on product packaging 80 such as a header card or the like. Trace 60 may be formed from conductive ink in a manner similar to that of peg board 30. Conductive trace 60 can take practically any imaginable shape and is not limited to the schematic representation shown in FIG. 4. Because trace 60 is conductive, and because it is in contact with conductive shelving 50, any powerable elements in the product packaging 80 itself, or the product itself, can be powered by display system 10. As an example, each product packaging can be provided with one or more LEDs or sound chips, for drawing in consumers with an especially snazzy and attractive display. In another example, each product packaging 80 may be equipped with a RFID chip (not shown), for example, programmed to transmit wireless signals representative of product information, which signals may be received by a telecommunication device associated with the customer. To conserve power, the chip in the product packaging 80 may emit the signals only when display system 10 detects the presence of a customer within a predetermined distance, for example, and transmits a command to the product packaging 80 to emit wireless signals. By way of non-limiting example only, if the product packaging 80 is a food product, the transmitted information may include, for example, ingredients, calories count and if there are any known allergenic ingredients in the product 80.

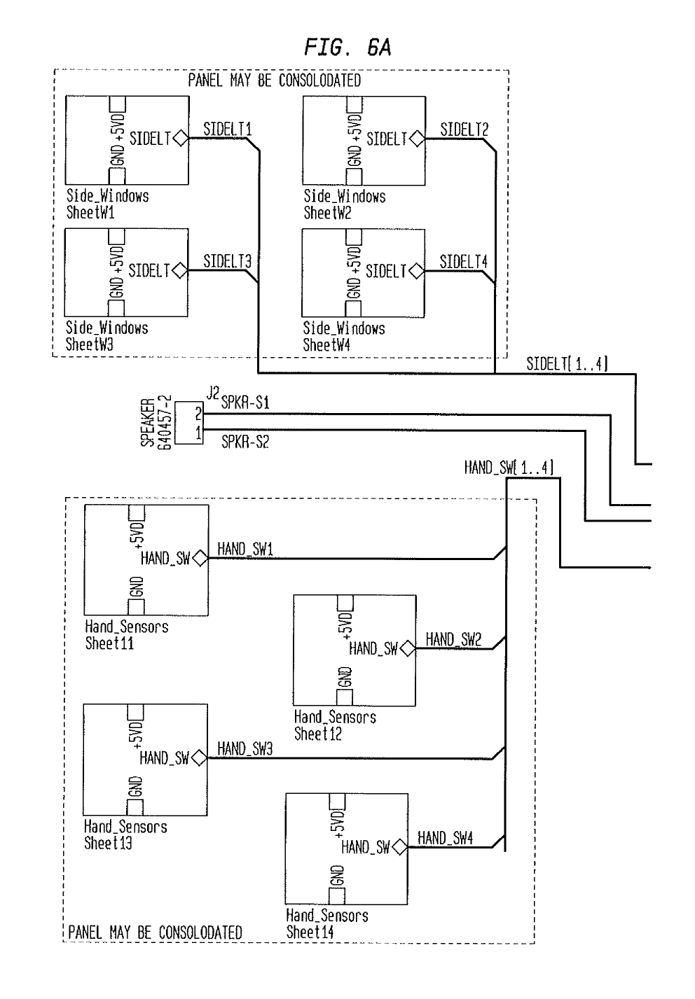

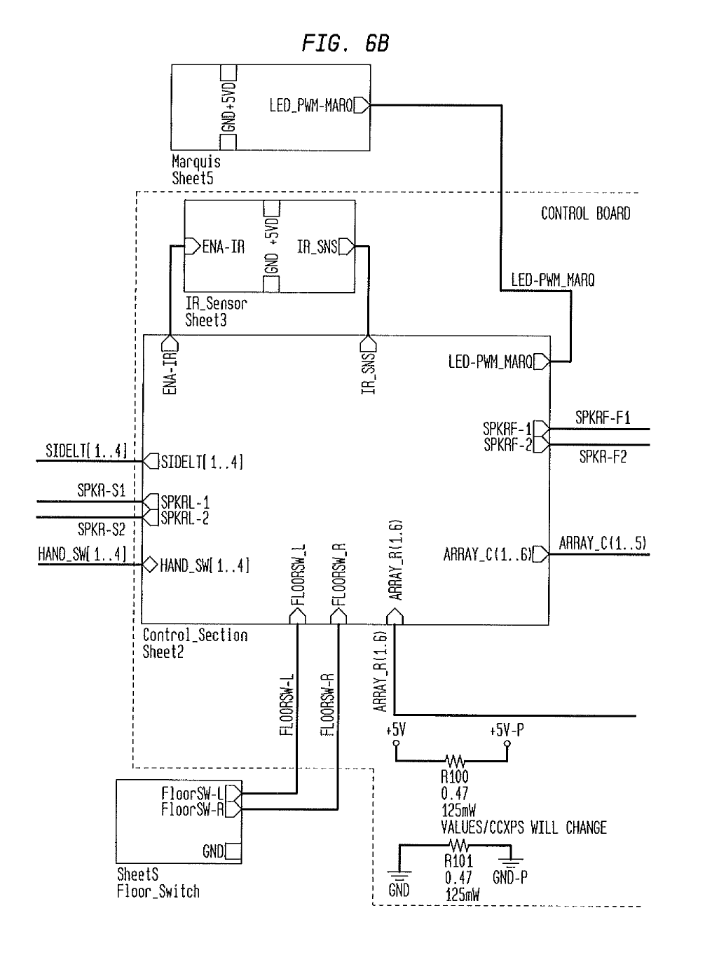

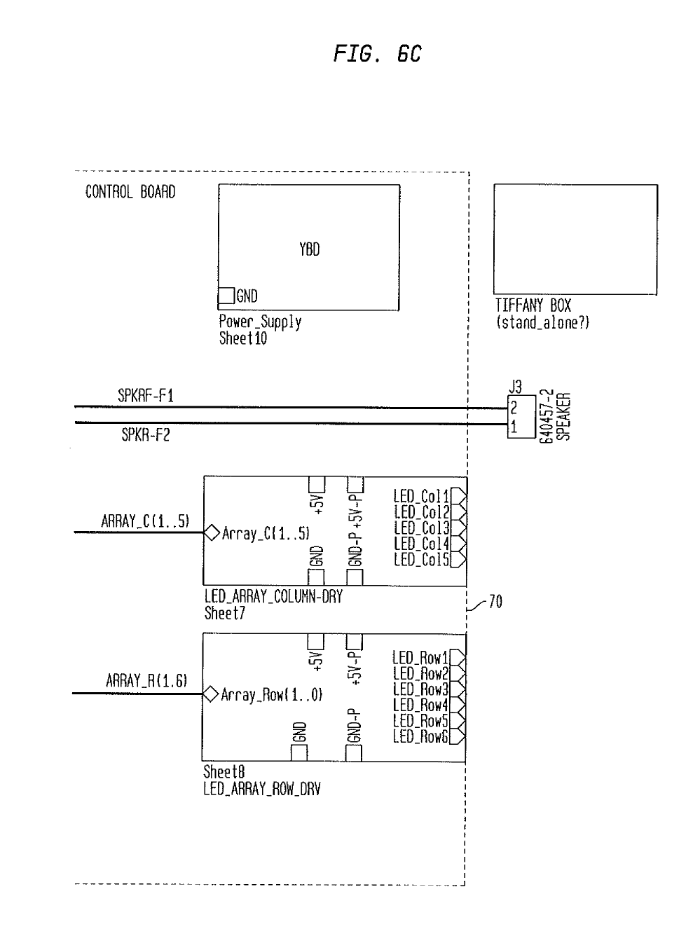

Moreover, different types of products 80, e.g., different sizes of a clothing item, or different softnesses of a toothbrush, or the like, may be readily distinguishable in the display by use of inventive powered display system 10. For example, if two products are on display system 10 and each contain a light or sound element, the lights (for example, LED) of one product may be provided with a reverse polarity to that of the other product. That way, via a control board 70 (FIG. 6) in base 20, one polarity can be powered at one given moment, and only those products with the lights having that polarity will be triggered, regardless of where it is on shelving 50 of display system 10. When the polarity is reversed, the other product's light or sound elements will be activated. Another option, suitable for display systems 10 having more than two different products, is to create different resistance values in each package 80, and control the power flow via the different resistances to trigger different elements in the different packages 80, for example, lighting elements of different colors, or different number of lighting elements.

In yet another embodiment, display system 10 may be configured to display related products. For example, if a customer picks up a product 80 from shelving 50, display system 10 may direct the customer's attention to another product related to the selected product 80. That product may be something that is customarily bought along with the selected product. By way of non-limiting example only, if the selected product 80 is a shirt, the related product may be a matching tie or a matching pair of trousers or a pair of cuff-links. Display system 10 may be configured to hold such related products on different shelves 501, 502, 503 of shelving 50. In another embodiment, such related products may be in another adjacent display system 10. By way of example only, the customer's attention may be drawn to the related products by lighting the related products or directing the customer to an appropriate display system 10 via audio suggestions, for example.

Referring again to FIG. 1, sensors 24, also preferably powered via conductive ink traces of peg board 30, allow for the consumer to interact with display system 10. In one embodiment, sensors 24 are capacitive touch and/or proximity switches. Each switch or touch point corresponds to one portion 28a, 28b, 28c, 28d of display panel 28. If the consumer touches or approaches one of the switches 24, it triggers some visual (or aural) response in display panel 28, e.g., a graphic image in one or more segments 28a, 28b, 28c, 28d of display panel 28 and trigger a sound and light module. Because these are all preferably wired via conductive ink traces, these segments 28a, 28b, 28c, 28d can all be modular, where all one need do is swap out one or more of the graphic segments 28a, 28b, 28c, 28d, but overall capabilities of display system 10 remain the same, or the graphic segments 28a, 28b, 28c, 28d of display panel 28 can be programmable and updateable.

In addition or in the alternative, the control board unit or controller 70 can be configured so that if a consumer is looking for a specific product or a specific size, touching or approaching one of sensors 24 causes the lights of all of the corresponding product be activated on one or more of the shelves 501, 502, 503 (e.g., via polarity, resistance, etc., as mentioned above). In either or other embodiments of sensors 24, it is possible to have capacitive and other pressure display panels 28, but they all require hardwire to be attached to a power source. By contrast, the exemplary embodiment utilizes conductive inks as wire replacements. Additionally, the conductive ink can be printed as an antenna to allow for capacitive touch points to either trigger at the surface with physical touch, or tune the antenna to activate a significant distance away (e.g., up to 3 feet away) from the contact point with body mass activation. Moreover, all parts of display panel 28 and base 30 can be designed to be modular in that they can each have a distinguishing capability that is molded into the parts, but have space for a graphic application to be removable that can be added to each part. This allows for mass production of standard parts, but customizable with individual graphics, still allowing for all the interactive capabilities mentioned herein.

In an exemplary embodiment, sensors 24 may also include, for example, a bar code scanner or an RFID tag reader, or such other mechanisms for identifying a product. Display system 10 may prompt a customer to scan a selected product and upon identifying the selected product, system 10 may then draw the customer's attention to other products related to the selected product.

By being able to distinguish between or among multiple different products, the display system 10 can differentiate which products 80 on shelving 50 are being sold at what rate and which are less successful. As such, display system 10 can accumulate significant amounts of real time sales and inventory data on multiple products 80 positioned on shelving 50. Even when a single type of product 80 is being displayed at a time on display system 10, the removal of one unit of the displayed product 80 from the shelving 50 changes the overall resistance of the display system 10 and the resistance of that shelf of shelving 50. As such, strict and precise monitoring of the quantity of the product 80 on display system 10 is possible by use of this display system 10, and loss prevention efforts can be made more successful (e.g., if five units of a product 80 have been removed from one or more shelves 501, 502, 503 of shelving 50 but only four have been paid for, security can be alerted to the missing fifth product).

Another advantage of the use of conductive traces 60 is the aggregation of consumer shopping habits, e.g., it can readily be determined which shelves 501, 502, 503 and which parts of a store draw consumers in more readily based on the speed at which shelf is depleted more rapidly than others. For example, multiple display systems 10 in a store may be connected to a server 1200 (FIG. 7) via a network, as schematically illustrated in FIG. 7. The number of customers stopping at and passing by each of the networked display system 10 may be detected by the respective display system 10 and transmitted to the server 1200 (FIG. 7). The server 1200 (FIG. 7), for example, can keep track of single consumer in the store moving from one display system 10 to another display system 10, thereby acquiring which of the products on the respective shelving units 50 did the consumer pick and which of the products on the respective shelving unit 50 did the consumer pass by. This can be done, for example, by tracking a telecommunication device, such as a cellular telephone, associated with the customer or via biometric information collected by the display system 10, as discussed below.

In addition to powering the hooks, shelves, drawers, etc., of shelving 50, the conductive ink traces of peg board 30 can distribute electrical power to the lighting elements, the video elements, the printed electronic displays and the sound elements on the hooks of shelving 50, independent of the product placed on the hook. The head of the hook may contain a UPC code, product logo, Price Sticker or a product identifier that can be powered via the display system 10 and light up in a programmable and controllable fashion. The light element may act as a back-light element to the UPC code area, or may simply contain a light source such as an LED that would shine or pinpoint light onto the product that would hang on the hooks or placed on any of the shelves or other product support mechanisms of shelving 50. An exemplary embodiment of such lighted elements is shown in FIG. 5A. Lights 52 are disposed on head 51 of shelving 50. When powered, they shine light backward away from the consumer onto the product being displayed on shelving 50.

Also, the inventive ink traces can power light and logo special effects. For example, powered shelving 50 may also project single, moving or light images or video such as product logos or other effects onto the surfaces such as the ground, the ceiling, the shelves 50, or other areas within the proximity of the display system 10. Power can also be distributed via the display system 10 to control one or more printed electronic displays integrated into the display system 10. An exemplary embodiment of such elements is shown in FIG. 5B. Here, a proximity, motion, heat, or other sensor 54 and a projector 56 are disposed on head 53 of the shelving 50. When sensor 54 detects the presence of a consumer within a predetermined distance therefrom, projector 56 is activated to cause an image to be projected. For example, the predetermined distance may range from about one (1) foot to about five (5) feet. Of course, depending on a particular application, the distances may be adjusted to take into consideration the nature of the products displayed, the store layout and other such relevant factors. In addition or in the alternative, a sound can be played when sensor 54 detects the presence of a consumer within a predetermined distance therefrom, or a signal can be sent to a mobile device carried by the customer within a predetermined distance thereform via a radio frequency system such as Bluetooth, etc. The predetermined distance may range from a few feet to a few hundred feet, depending on the requirements of a given application, the nature of the products displayed, the size and layout of the store and other such relevant factors.

As mentioned above, display system 10 can be made as interactive and “intelligent” as desired, depending in part on the control board 70 and concomitant wiring. One embodiment of a wiring diagram for such a control board 70 is depicted in FIG. 6. This wiring format is one of many ways to wire a display system 10 to trigger (based upon sensors that include proximity, touch, capacitive, pressure, etc.) lighted marquee headers, light patterns of the products on the display system 10 via touch or the powerpass bars, appropriate and predetermined sound clips associated with each sensor, light boxes, etc. One of ordinary skill in the art can appreciate the functioning of the elements of FIG. 6 and can further appreciate that what is depicted in FIG. 6 is only one version of the relevant circuitry of the display system 10 and is not intended to be limiting in any way.

By using the above elements in various combinations, the inventive display system 10 can accomplish at least the following.

One or more sound elements may be triggered or accompany upon demand, i.e., responsive to a consumer input, or may be preprogrammed to trigger responsive to any trigger or activation of the proximity sensors, floor mat, touch sensors, product contact, or a timing element associated with display system 10. The display system 10 allows for the control of the distribution of sound to a particular speaker (when multiple speakers are present), associated therewith, and/or the play back of specific musical or sound elements based upon the area of the sensor touched or by proximity of a customer to the display system 10. Sound elements may be, but are not required to, triggered in conjunction with a light element associated with display system 10. One or more sound elements may also be triggered to a remote wireless or wired speaker not directly arranged on the display system 10, but may still be controlled by the display system 10 programming and trigger. Sound elements may be modular in nature, and allow for the downloading or updating of new audio on demand via a variety of means. These can include storage devices, mobile, Wi-Fi, chips or other internet connected devices via the display system 10.

The display system 10 may contain a multitude of different sensors (capacitive, touch, biometric, proximity, force registers, sound, light, etc.) that may be used to trigger different elements of the display system such as light, sound, tracking body movement or lack thereof in front of or around a display system. The sensors may be linked to a CPU or other similar controller electronics that simply store data, or they may be more active in triggering a response based upon sensor feedback such as biometric feedback on heart-rate, respiration, etc.

As mentioned to some extent above, the display system 10 can achieve a significant amount of metric data gathering. As examples, depending on the type and location of the sensors employed, the inventive display system 10 can track the number of times the display system has been passed by a person, track the number of times a specific product has been removed from a hook or merchandise position of shelving 50, the number of products on a hook of shelving 50, sweep detection for when an entire hook of product is swept off shelving 50, with the ability to send a signal to indicate the same for loss prevention purposes to the server 1200 (FIG. 7), out of stock notification, a product removed from a shelf of shelving 50, what shelf and location, with corresponding data such as time and date, etc. Facial recognition, signal interception, bounce back signaling and response are all contemplated functions of the display system 10. The display system 10 is capable of gathering data via wired or wireless communicated text, email, or cell mechanism to a secure storage and encryption device that can upload information remotely via wireless protocols to and from server 1200 (FIG. 7).

Referring now to FIG. 7, a system is illustrated including a number of display systems 1010, 1020, 1030, 1040 connected to a server 1200 via a network 1100. Each of display systems 1010, 1020, 1030, 1040 may take the form of, for example, system 10 described above. In an exemplary embodiment, network 1100 may take the form of a wireless network, a wired network, or a Virtual Private Network (VPN) operational, for example, on public telecommunication infrastructure. Since such networks are known in the art, they are not described in further detail for the sake of brevity. Server 1200 may be incorporated in one of display systems 1010, 1020, 1030, 1040 or may be located at a remote location, either inside or outside the store. Based upon data gathered on users from the metric data gathering and/or sensors, or via accessing data either in the programming or remotely accessing a database on server 1200, the display systems 1010, 1020, 1030, 1040 can recognize, for example, prior purchasers. Once recognized, one or more of the display systems 1010, 1020, 1030, 1040 can, for example, customize and cater specific coupon offerings based upon the purchase history, the demographics, and other promotional opportunities to dispense offers in a manner of intelligent couponing to the selected customer. This can be achieved in any number of ways, e.g., by physical coupon output at the display system 1010, 1020, 1030, 1040, or electronically by sending to a mobile device associated with the selected customer, for example via Wi-Fi, Bluetooth, radio frequency or any other wireless telecommunication technology known in the art, or using other digital or hardcopy forms of promotions to dispense directly to the consumer, the consumer's cell phone, or the like. Indeed, intelligent couponing need not be required to recognize a specific purchaser, but can identify aspects of even a first time or would-be purchaser simply by determining how long a consumer stands in front of one of display systems 1010, 1020, 1030, 1040, how long a consumer stands in front of a given portion of one of display systems 1010, 1020, 1030, 1040, what products on shelving 50 s/he is touching or moving, and the like. Other market data and intelligence can be collected such as any of the following: the number of consumers that have passed the display systems 1010, 1020, 1030, 1040, versus the number that have stopped, touched, or removed product 80 from shelving 50 of one or more of display systems 1010, 1020, 1030, 1040; which product was removed from shelving 50 of one or more of display systems 1010, 1020, 1030, 1040, from what location on shelves 501, 502, 503 of one or more of display systems 1010, 1020, 1030, 1040; a comparison of removed product 80 from one or more of display systems 1010, 1020, 1030, 1040 with the Point of Sale data to determine the conversion rate of product 80 removed to product scanned, and the time between visiting one or more of display systems 1010, 1020, 1030, 1040 and check-out.

The inventive display system 10 is designed to be manufactured as new, or to work with existing non-intelligent display systems. The modular systems allow for contact to a power supply via the conductive elements attached to the grid where the contacts are powered, and the hooks, shelves, or other fixtures of shelving 50 that hold the products 80, and the light and/or the sound elements. This allows, for example, a single hook of shelving 50 to be powered and allow for non-powered product to be activated (be it light or sound) on an existing non-intelligent fixture. Further, unpowered or powered individual shelves can be attached either directly to a signal/power source on the display system 10, allowing for the entire shelf, or only specific locations on a shelf 501, 502, 503 of a shelving 50 to be powered so that items thereon can interact with, or be powered by the shelf 501, 502, 503. Additional shelf brackets can be placed on the display system 10 allowing for signal/power distribution within the brackets or the attached shelving or other components and hangers to be used as a further distribution element such that any shelf or hanger that touches the bracket or pole can further carry the signal/power.

The inventive display system 10 allows for packaging interaction where the product 80 has no internal power source. With the inclusion of a light, LED or printed display element (and any appropriate resistor), and the conductive ink trace, or hard-wired, that allows for the direct contact with the hooks, shelves, drawers, 501, 502, 503 that are powered, the product 80 has the ability to light up, trigger images and sounds and be completely controllable and programmable via the inventive display system 10. Similarly, where a package 80 is provided with an internal power source, the package 80 may still be controlled and programmed to work with or interact with the fixture 10 or person, with the inventive display system 10 controlling the internal product element whether it be sound, light, etc., but not require any outside power. This may be accomplished via conductive materials or with hard-wired power elements on peg board 30 as well as shelving 50.

The power source that powers the display system 10 may be rechargeable via a standard 110 or 220 volt plug, direct current via battery replacement, solar, or other energy harnessing system, inductive or via capacitive or other energy radiation or harnessing systems.

The fixture control and programmable aspects may be changed or modified via a variety of systems including cell phone, download from a wired or wireless network, for example, via server 1200 (FIG. 7), internal memory, flash components, and the like.

The display system 10 is designed for on the fly graphic changes to allow for a quick product change over in the field, supported by the programmable changes to support specific products or company information. Electronic printed displays mounted to package hooks, shelf channels, shelves, headers, or wings of shelving 50 can also be powered by the inventive display system 10. Graphics, for example of display panel 28 or segments 28a, 28b, 28c, 28d, can be swapped out over a standard touch or capacitive response pattern, where the graphics are designed to be interactive when triggered.

The invention is not limited to the above description. For example, infrared, Bluetooth, and other radio frequency controllers may be incorporated herein to allow for further interaction for internal control distribution or for external fixture element controls, triggers, sensors, or part movement.

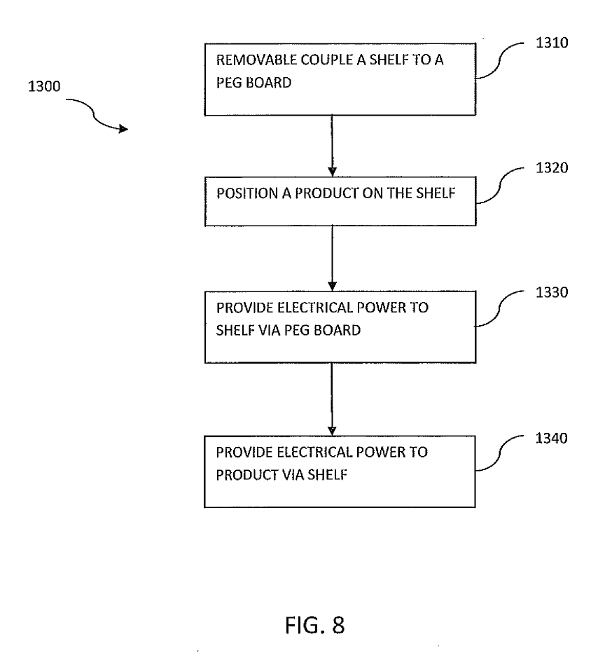

Referring now to FIG. 8, there is illustrated a flow chart 1300 for displaying a product, according to an aspect of the invention. At block 1310, a shelf 501 is removably coupled to a peg board 30. As described above, the peg board 30 is configured to receive electrical power from a power source and to be in electrical communication with the shelf 501 coupled to the peg board 30. A product 80 is positioned on the shelf 501, at block 1320. As described above, product 80 is configured to at least receive electrical power from shelf 501. At block 1330, electrical power may be provided to the shelf 501 via the peg board 30. Electrical power is further provided to the product 80 via the shelf 501, at block 1340.

Having described certain embodiments of the invention, it should be understood that the invention is not limited to the above description or the attached exemplary drawings. Rather, the scope of the invention includes any equivalents thereof as would be appreciated by one of ordinary skill in the art.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A configurable merchandise display system comprising:
a base;
a peg board associated with said base, said peg board configured to conduct electrical current and comprising a plurality of electrical sockets;
a shelf configured to be removably coupled to and in electrical communication with said peg board via at least a first and a second of said plurality of electrical sockets, said shelf configured to removably accommodate at least one product thereon, and to be in electrical communication with said at least one product; and
a controller configured to control at least an electrical current flowing to and from said peg board and said shelf.

2. The system of claim 1, wherein said peg board further comprises a plurality of electrically conductive elements selected from the group consisting of conductive ink prints, conductive ink traces and copper wiring.

3. The system of claim 1, wherein said peg board further comprises a printed ink trace applied to at least one of a front and a back side of said peg board.

4. The system of claim 1, wherein said peg board further comprises an embedded conductive ink layer.

5. The system of claim 1, wherein said peg board is configured to receive electrical power from a first power source, and
wherein said shelf is configured to draw electrical power from said first power source via said base or from a second power source.

6. The system of claim 1, wherein said shelf further comprises one or more of a lighting element, an audio element, a data acquisition element, a touch sensor, and a proximity sensor.

7. The system of claim 1, further comprising a projection element configured to project at least one of light, a light effect, a still image, and a video image.

8. The system of claim 1, wherein said controller is configured to maintain the electrical current flowing through at least one of the peg board and said shelf, from exceeding a predetermined threshold.

9. The system of claim 1, wherein said base further comprises a display panel.

10. The system of claim 1, further comprising one or more of a capacitive sensor, a touch sensor, a biometric sensor, a proximity sensor, a force register, a sound sensor, and a light sensor, said one or more sensors being in communication with said controller.

11. The system of claim 1, further comprising one or more wireless communication devices for at least one of an internal wireless communication within the fixture and an external wireless communication with an external system, wherein said wireless communication devices comprise one or more of Bluetooth devices, infrared devices and radio frequency devices.

12. A method for displaying a product comprising the steps of:
removably coupling one or more shelves to a peg board, the shelf configured to be in electrical communication with the peg board, the peg board configured to receive electrical power from a first power source; and
positioning a product on the shelf, the product configured to be in electrical communication with the shelf.

13. The method of claim 12, further comprising the step of sensing, via a change in the electrical current flowing between the shelf and the peg board, removal of the product from the shelf.

14. The method of claim 12, further comprising the step of establishing a wireless communication, via a wireless communication device, with a telecommunication device within a predetermined distance from the peg board.

15. The method of claim 12, further comprising the step of actuating one or more of a visual and an audio element responsive to a detection of the presence of an individual within a predetermined distance from the peg board.

16. The method of claim 12, further comprising the step of controlling, via a controller, an electrical current flowing through one or more of the peg board, the shelf and the product.

17. The method of claim 12, wherein at least a first and a second product are positioned on the shelf, said method further comprising the step of differentially displaying the first and second products using at least one of a light element and an audio element.

18. The method of claim 12, wherein a plurality of products are positioned on the shelf, said method further comprising the step of selectively displaying one or more of the plurality of products responsive to an input from an individual.

19. The method of claim 12, further comprising the step of acquiring, via electrical communications with the shelf, real time sales and inventory data regarding at least one product positioned on the shelf.

20. A system comprising:
a configurable merchandise display system; and
a server,
wherein said display system is configured to be communicatively coupled to said server, and
wherein said configurable merchandise display system comprises:
a base;
a peg board associated with said base, said peg board configured to conduct electrical current and comprising a plurality of electrical sockets;
a shelf configured to be removably coupled to and in electrical communication with said peg board via at least a first and a second of said plurality of electrical sockets, said shelf configured to removably accommodate at least one product thereon, and to be in electrical communication with said at least one product; and
a controller configured to control at least an electrical current flowing to and from said peg board and said shelf.
